(19) United States
(12) Patent Application Publication
(10) Pub. No.: US 2026/0319818 A1
(43) Pub. Date: Oct. 15, 2026

(54) SYSTEMS AND METHODS FOR FACILITATING NEXT BEST ACTIONS

(71) Applicant: WELLS FARGO BANK, N.A., San Francisco, CA (US)

(72) Inventors: Prateek Singh, Phoenix, AZ (US); Mandar Shasane, Phoenix, AZ (US); Abhijit Nandan Kuwar, Phoenix, AZ (US); Ram Gopal, Dublin, CA (US); Raghavendra Rao, Cary, NC (US)

(21) Appl. No.: 19/177,361

(22) Filed: Apr. 11, 2025

(51) Int. Cl. G06F 9/451; H04L 67/306

(52) U.S. Cl. CPC G06F 9/453; H04L 67/306

(57) ABSTRACT

Systems and methods for smart servicing are described. The operations of the systems and methods can include receiving an event identification and a credential verification and generating a login event including the event identification and credential verification. The operations can include monitoring two or more data sources via parallel processing to generate a set of user attributes for each entity of a set of one or more entities and identifying an associated entity of the set of one or more entities based on the login event. The operations can include determining a user behavior profile for the associated entity based on the set of user attributes of the associated entity and determining an action recommendation and one or more electronic channels for communicating the action recommendation based on the login event and user behavior profile. The operations can include transmitting the action recommendation to the one or more electronic channels.

### FIELD OF INVENTION

The present disclosure generally relates to user interfaces, and more specifically to systems and methods for recommending and facilitating interactions within electronic user interfaces.

### BACKGROUND

Computing systems and applications may rely on a variety of distinct interfaces for facilitating user interactions. As an example, a given software application may interface with users via mobile applications, web-hosted services, communication channels such as text and email, in addition to human-in the loop systems including call centers. Determining the most effective messages to communicate via the interfaces, and which configuration of interfaces to use remains a challenge in user interface design.

### SUMMARY

According to certain examples, a method is described. The method can include receiving an event identification and a credential verification, and generating a login event including the event identification and credential verification. The method can include monitoring two or more data sources via parallel processing to generate a set of user attributes for each entity of a set of one or more entities and identifying an associated entity of the set of one or more entities based on the login event. The method can include determining a user behavior profile for the associated entity based on the set of user attributes of the associated entity and determining an action recommendation and one or more electronic channels for communicating the action recommendation based on the login event and user behavior profile. The method can include transmitting the action recommendation to the one or more electronic channels.

Another example relates to a system including one or more processors configured to perform operations. The operations can include receiving an event identification and a credential verification, and generating a login event including the event identification and credential verification. The operations can include monitoring two or more data sources via parallel processing to generate a set of user attributes for each entity of a set of one or more entities and identifying an associated entity of the set of one or more entities based on the login event. The operations can include determining a user behavior profile for the associated entity based on the set of user attributes of the associated entity and determining an action recommendation and one or more electronic channels for communicating the action recommendation based on the login event and user behavior profile. The operations can include transmitting the action recommendation to the one or more electronic channels.

A further example relates to a non-transitory computer readable medium comprising instructions that, when executed by one or more processors, cause the one or more processors to perform operations. The operations can include receiving an event identification and a credential verification, and generating a login event including the event identification and credential verification. The operations can include monitoring two or more data sources via parallel processing to generate a set of user attributes for each entity of a set of one or more entities and identifying an associated entity of the set of one or more entities based on the login event. The operations can include determining a user behavior profile for the associated entity based on the set of user attributes of the associated entity and determining an action recommendation and one or more electronic channels for communicating the action recommendation based on the login event and user behavior profile. The operations can include transmitting the action recommendation to the one or more electronic channels.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

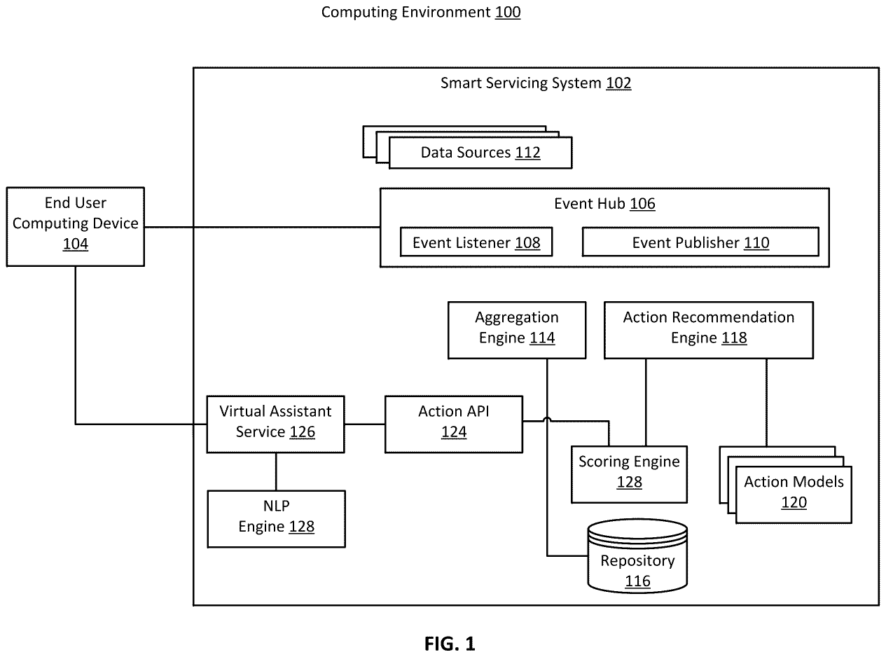

FIG. 1 shows a computer environment implementation of a smart servicing system, according to certain examples.

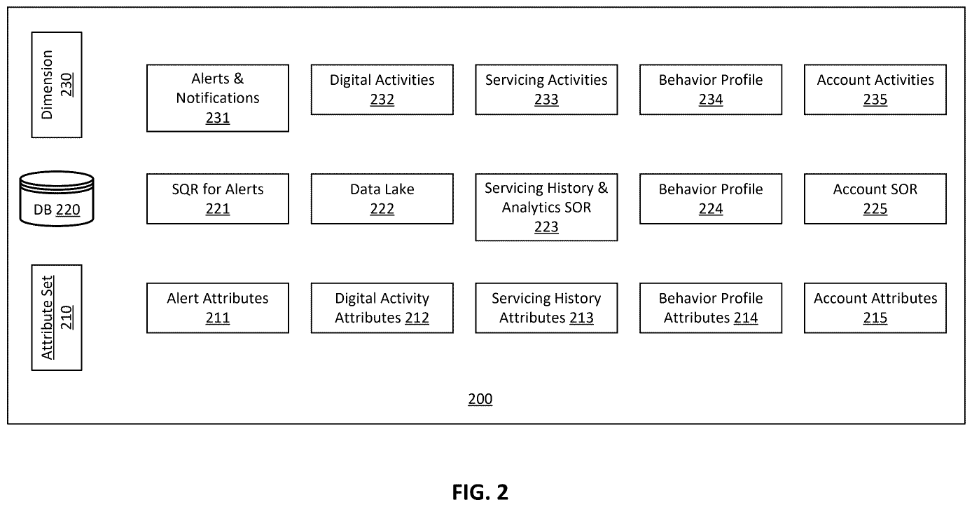

FIG. 2 shows sets of attributes used to determine action recommendations, according to certain examples.

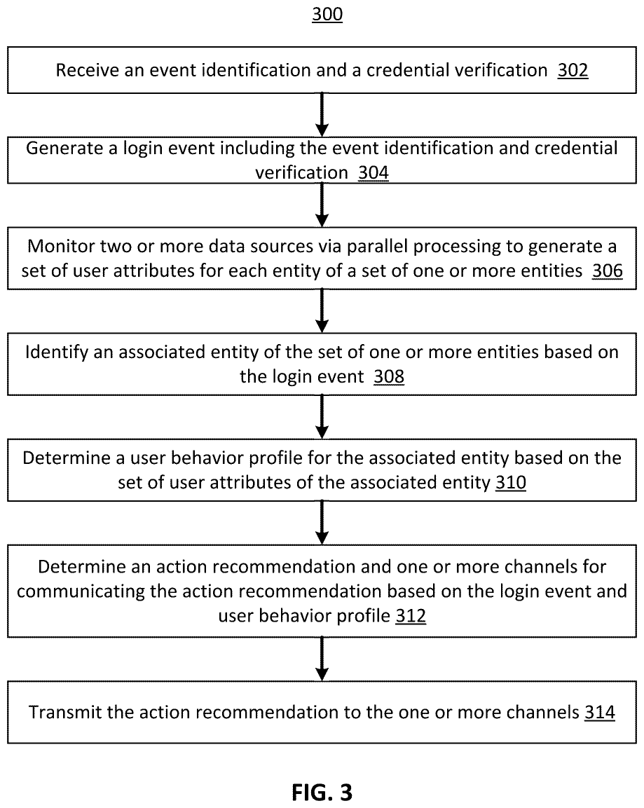

FIG. 3 shows a process for determining action recommendations, according to certain examples.

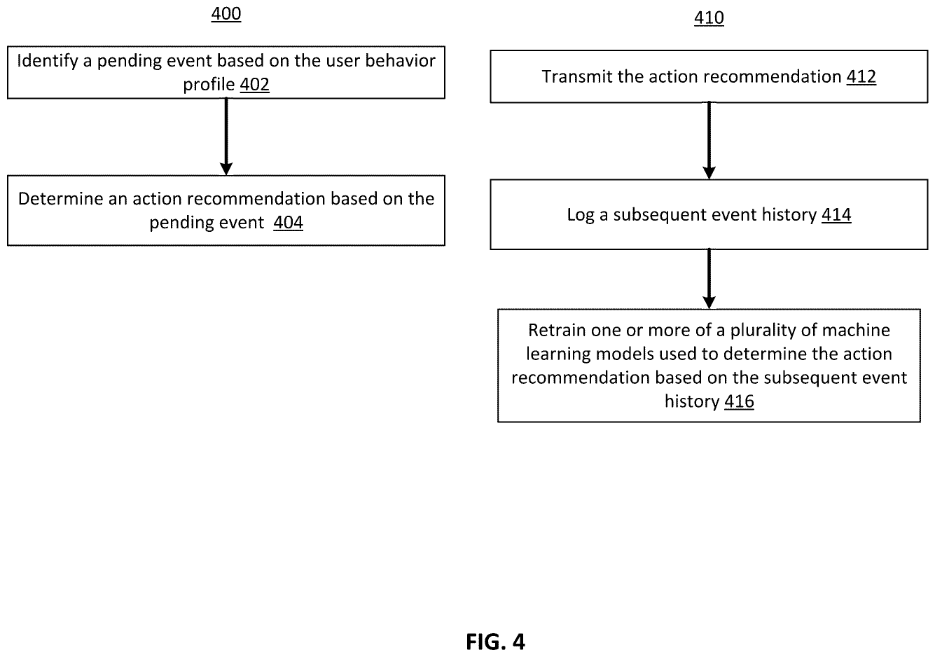

FIG. 4 shows processes for determining action recommendations based on user profiles and associated user attributes, according to certain examples.

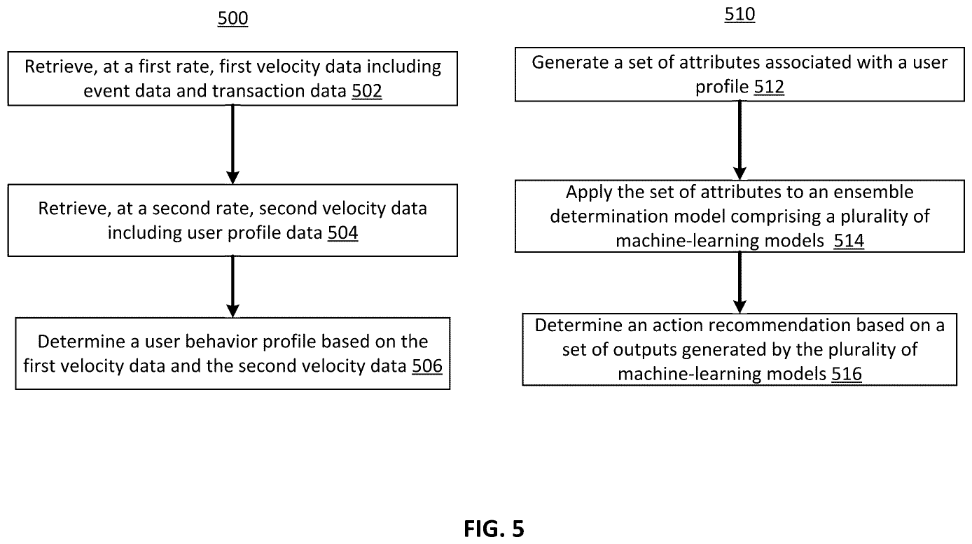

FIG. 5 shows processes for determining action recommendations, according to certain examples.

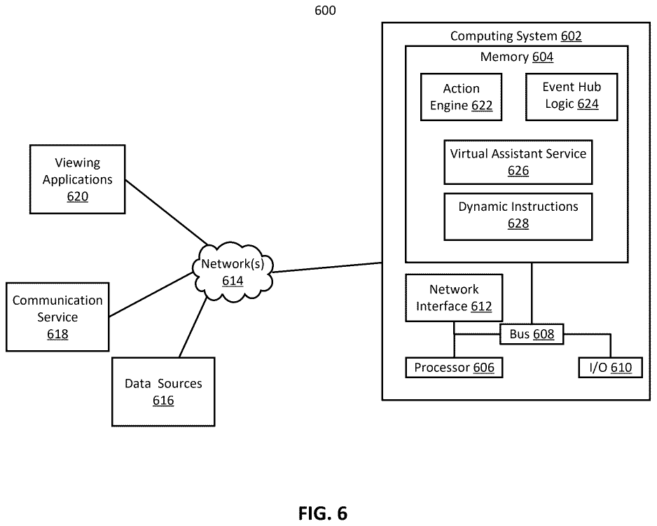

FIG. 6 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Computing systems and applications may rely on a variety of distinct interfaces for facilitating user interactions. Such systems are designed to facilitate a user experience by providing interactions to guide users. Such interactions can include alerts, messages, and other communications to guide users in response to various events. As an example, a computer monitoring application may detect a virus intrusion event on a local device. The computer monitoring application may then prompt a user to respond to the detected virus to prevent further damage to a larger computing network. There are a multitude of ways in which the application may prompt the user, including which channel to prompt the user through (i.e., via a mobile app, email, text, call, web-portal and the like) and the specific prompt to provide the user (e.g., prompt the user to review the virus, to shut down the associated device, enable certain security protocols and the like). The array of means by which applications interface with users provides challenges to existing techniques. Current software interfaces lack the ability to intelligently harness the number of channels and responses available at their disposal to provide the most effective interface tailored to a given user.

Effectively guiding the user through the potential options to take, and how the guidance is presented remains a challenging task. Current systems may be deficient from the user's perspective, causing user dissatisfaction and leading users in aggregate to overload specific channels. As a practical example, fraud and security applications may identify fraudulent events such as a suspicious transaction on a user's account. In response, the application must determine how to notify the associated user, and what actions the user should take in response to the fraudulent event. The fraud and security application may be configured to shut off an associated account of a user in response to detected fraud and provide an email or text alert indicating that the account has been disabled to protect the account. However, this default response, while sufficient for some users, will be insufficient for others. As a result, users in aggregate may turn to a call-center or phone line to determine how to proceed in view of the detected fraud. These inefficiencies can lead to call-centers being overloaded as the fraud and security application's default guidance provided an insufficient interface for a significant number of users. Similarly, inefficient guidance can lead to excessive interactions in computing environments, including more function calls and API calls than would be required for a better tailored user interface and system. Therefore, improved interfaces for guiding users through events can lead to improvements in computing efficiencies such as bandwidth reduction and reduced processing calls by reducing the number of electronic interactions necessary to provide resolution of the detected event.

Certain aspects described herein overcome the above identified inefficiencies in electronic user interfaces and event-responsive user applications.

In one illustrative example, a smart servicing system (also referred to as a “next best action system”) can facilitate a user's experience via manipulation of one or more user interfaces. In a first step, a system, which may or may not include the smart servicing system, detects an event which is transmitted to a user by means of one or more electronic channels. The event can include security violation, virus, suspected fraudulent transaction, health alert, or any other event requiring response by the user. In response to the alert, the user will log-in or otherwise authenticate into the smart servicing system. The user's log-in event can be logged as part of event data which is then transmitted to the smart servicing system.

The smart servicing system elicits data from a variety of data sources, including various repositories, APIs, systems of record, and the like. The variety of data sources can capture different events related to a user's experiences and customer life cycle. For example, a first data source can capture events including card cancellation actions, identified potential fraud, user password resets and the like. Meanwhile, a second data source can provide information related to the user's digital activities including preferred channels for digital communication, preferred times of mobile device login, and the types of electronic devices the user prefers to interact with.

The variety of data sources can provide events and data retrieved by event listeners which may then be aggregated into attributes to determine a next best action that the user should take to respond to the event, in addition to the best channel(s) of communication to transmit the next best action to the user. The next best action refers to an action or set of actions most tailored to the user to facilitate the user's interaction with the smart servicing system. For example, a first user may be determined, by the smart servicing system, to be more responsive to communications through a mobile app than a second user. The first user may also be determined by the smart servicing system to more frequently check their account histories and to have more contingencies on an associated account (i.e., more subscription based services which bill from the account). The smart servicing can then prepare a more tailored next best action to the first user, which would provide alerts and notifications to the user through the mobile application, where the alerts and notifications first present the user's account history and to further recommend cancelling contingencies to the account. Meanwhile, in response to a similar event provided to the second user, the smart servicing system will provide a different interface where guidance related to the event may be transmitted by an email log or via text. Various other examples of configurations of next best actions, recommendations, and channels of communication may be provided, each responsive to a different event and a different user based on user associated attributes may be generated. In such a manner, the smart servicing system can tailor user interfaces to respective users to guide the users through various events. Compared to other interfaces which may seem slow, complex, and difficult to navigate, the described smart servicing system's user-specific interfaces can improve the functioning of various computing systems.

To determine user preferences, such as preferred channels of communication, preferred interaction patterns, and behavioral patterns, the smart servicing system can harness an ensemble model system including a series of machine-learning models, each trained to specific insights related to the user. Each machine-learning model can be trained on a respective dimension of user and event attributes or a combination of user and event attributes. The attributes used to train the models, and the attributes received by the machine-learning models used to determine the next best action can include alert attributes, digital activity attributes, servicing activity attributes, user profile attributes, account attributes, and the like. The types of machine-learning models, and the sets of attributes used to train the models and to determine next best actions will be described further according to the various examples described herein.

### Example Network Architecture for a Smart Servicing System

FIG. 1 shows an implementation of a smart servicing system, according to certain examples. The embodiments according to FIG. 1 are shown to illustrate the logical and physical implementation of the smart servicing system according to certain examples. Other embodiments, however, are possible. For instance, certain components may be shown as distinct components to illustrate the progression of the data flow, while according to some embodiments, the physical implementation of such components may be implemented across the same device. It is to be appreciated that the example embodiments according to FIG. 1 are provided for illustrative purposes. Examples of implementations of the computing environment 100 capable of implementing the described embodiments of FIG. 1 are discussed further with respect to the computing system of FIG. 6.

In the example of FIG. 1, a computing environment 100 is shown including an end user computing device 104 interfacing with a smart servicing system 102. The smart servicing system 102 includes a variety of engines, modules, and other sets of programmable instructions for generating action recommendations and for causing the display of the action recommendations across a variety of channels and interfaces.

The end user computing device 104 includes a user interface for providing and receiving event information and user credentials. A user may interact with the end user computing device by authenticating themselves and providing credentials in order to access action recommendations provided by the smart servicing system 102. Interactions can also be prompted to users associated with the end user computing device via provided events. For instance, the smart servicing system 102, or another system communicatively coupled to the end user computing device 104 may transmit an alert indicative of an event to the end user computing device 104. The event can include any operation requiring user review or intervention. One example of an event can include detected fraudulent activity on a user's financial account. Another example may relate to a detected failure in a computing network. Other examples still can include a detected biometric exceeding a threshold value. In each case, the event, either determined by the smart servicing system, or another system, is notified to the end user computing device 104 via an alert. In response, a user may provide credential verification into the end user computing device 104 to access a privileged environment where the end user can communicate further with the smart servicing system 102. Credential verification can include password verification, multi-factor authentication, biometric authentication, and the like. The end user computing device can include any variety of devices such as a mobile phone, laptop, home computer and the like.

Upon credential verification, the end user computing device 104 or the smart servicing system 102 can generate a login event. The login event can include metadata related to the credential verification such as time the credential verification was performed, the location performed at, the specific type of end user computing device 104 the credential verification occurred from, whether multiple attempts at credential verification were attempted, the channel by which the credential verification was performed, and the like. The login event can be transmitted to the smart servicing system 102 for analysis related to action recommendation determinations described further below.

The login event received by the smart servicing system 102, can be received at an events hub 106 within the smart servicing system 102. The events hub 106 can be communicatively coupled to one or more event listeners 108 and event publishers 110 which may be used to interface with various data sources 112 and engines within the smart servicing system 102. Multiple event listeners 108 and event publishers 110 may be implemented via parallel processing to simultaneously or asynchronously detect, process, and handle events received as received from the end user computing device 104 and the data sources. Various event listeners 108 may be set to monitor at different rates to account for different data velocities of different data sources 112.

Data sources 112 can include various data sources associated with the an entity, either retrieved via verified credentials, or with the end user computing device 104. Data sources can comprise Apache Kafka logs or other distributed log-based or queue-based infrastructures for logging and managing events which may be received by internal or external sources. The data sources 112 can provide for real-time, high-speed data ingestion of events from the internal and external sources. Internal and external sources providing events include transaction based logs (e.g., recurring billing payments, account status summaries), user-induced event specific (e.g., cancelling a card, previous access attempts made to various user channels and the like), and/or rule-based specific (e.g., events generated in response to rules being triggered, indicative of suspicious behavior).

Events and data received at the events hub 106 may then be propagated to an aggregation engine 114. The aggregation engine 114 can aggregate each set of events and data received by the events hub 106 and parse the events and data into attributes and features for storage in a repository 116 and subsequent processing by the action recommendation engine 118. Examples of attributes and features which may be aggregated by the aggregation engine 114 and stored in the repository 116 include those discussed with respect to FIG. 2.

Events and data stored in the repository 116 as attributes and features can be accessed by an action recommendation engine 118 configured to determine an action recommendation for the user a specific user logged by the smart servicing system 102 via interaction on the end user computing device 104. The action recommendation engine 118 can comprise an ensemble machine learn model comprising multiple individual action models 120 each trained on separate sets of features to make individual action recommendations, and in some examples the action recommendation engine 118 can comprise a single machine-learning model trained on a combination of sets of attributes which may have otherwise been used to train the respective action models 120. The separate sets of features can correspond the attribute dimensions discussed further with respect to FIG. 2. For instance, each of the action models 120 may be trained on a respective attribute dimension including an alerts dimension, a digital activities dimension, a servicing activities dimension, a user profile dimension, and/or an account activities dimension. Separate training of each respective action model 120 for implementation in the action recommendation engine 118, as an ensemble model, can lead to more accurate predictions and action recommendations when the action recommendation engine 118 accesses a user behavior profile of a given entity which accessed the end user computing device 104.

The action recommendations, as generated by the action recommendation engine 118 can be stored in the same repository 116 or another repository 116 for retrieval by an action API 124, providing an interface for the end user computing device 104. Thus, the action recommendation engine 118 can periodically monitor events of an entity, received at the event hub 106 from the end user computing device 104, and generate updated action recommendations which are stored in the repository 116 for subsequent retrieval via the action API 124. The action recommendations generated and stored in the repository 116 may similarly be performed responsive to user actions as recorded by the event hub 106.

The action API 124 can interface with the end user computing device 104 via a virtual assistance service 126. The virtual assistance service 126 can include a programmable interface allowing users to communicate with the smart servicing system 102, where the virtual assistant service 126 causes the display of the action recommendation, responsive to requests initiated by the end user computing device 104. Requests via the end user computing device 104 can include accessing the virtual assistant service 126 via login and authentication. For instance, upon login and authentication into the virtual assistant service 126, a login event can be triggered, serving as the request to the virtual assistant service 126 which retrieves a predetermined action recommendation from the repository 116, as retrieved via the action API 124. Thus, on startup or access of the virtual assistant service 126, an action recommendation can automatically be presented onto the end user computing device 104. In the same or other examples, further interfacing with the virtual assistant service can generate action recommendations. For instance, a user may request additional action recommendations via the virtual assistant service 126, or may provide feedback that the user was unsatisfied with an action recommendation provided via the virtual assistant. According to further examples described with respect to FIG. 4, further interactions with the virtual assistant service 126 responsive or non-responsive to provided action recommendations can provide feedback to the action recommendation engine, causing the action recommendation engine 118, via a scoring engine 128 to further tune to the associated entity interfacing via the virtual assistant service 126.

The virtual assistant service 126 can include a natural language processing (“NLP”) engine 128 for parsing user input received via the virtual assistant service 126 and for providing text generated action recommendations back to the user. The NLP engine 128 can be implemented to perform additional tasks such as user sentiment analysis, which may serve as feedback used to further tune the action recommendation engine 118. For instance, the NLP engine 128 can be used to detect whether a user interfacing with the virtual assistant service is content or discontent with a provided action recommendation, based on the determined sentiment, the virtual assistant service 126 can communicate the determined sentiment to the scoring engine 128.

The scoring engine 128 can include programmable logic for manipulating the weights of various action recommendations as generated by the action recommendation engine 118. Manipulating weights can include tuning parameters and/or hyperparameters the action recommendation engine 118 or the associated action models 120. The scoring engine 128 can determine whether to retune the action recommendation engine 118 or action models 120 based on direct feedback received via the virtual assistant service 126 (e.g., a binary thumbs up or thumbs down interface or a scaled rating such as a one to five star rating tied to provided action recommendations) or via indirect feedback. Indirect feedback can include sentiment analysis provided by the NLP engine 128, or further monitoring and analysis of subsequent actions and events received from the end user computing device 104 as recorded by the event listener 108. Additional examples of operations of the scoring engine 128 are discussed with respect to FIG. 4.

### Example Attributes for Determining Next Best Actions

FIG. 2 shows a table including examples of different attributes across different domains and databases used for determining next best actions, according to certain embodiments. For illustrative purposes, the table 200 is described with reference to implementations described above with respect to one or more examples described herein. Other implementations, however, are possible. In some aspects, the only a portion of those attributes included in table 200 may be implemented in program code that is executed by one or more computing devices such as the computing environment 100 of FIG. 1.

Table 200 is shown including attribute sets 210 categorized by respective databases 220 and dimensions 230. Such categorizations are illustrative according to the example table 200 of FIG. 2 and not intended to be limiting. For instance, each database 221-225 may comprise the same physical database where data is segregated according to different techniques.

The attribute set 210 is shown including alert attributes 211, digital activity attributes 212, servicing activity attributes 213, behavior profile attributes 214, and account attributes 215. Each attribute within the attribute set 210 can correspond to a given user profile identified as having accessed the end user computing device 104 and virtual assistant service 126, where the attributes were processed by the aggregation engine 114 from various data sources 112. For the purpose of the example of FIG. 2, the attributes are discussed with respect to a single user profile associated with an entity accessing the smart servicing system. It is to be appreciated that attributes can be generated for each user profile which has access to the smart servicing system prior to, during, and after a given access event triggered by the entity associated with a given user profile.

Alert attributes 211 can include attributes generated from triggering events serving as attribute drivers. Examples of alert attributes 211 can include an alert history of alerts previously transmitted to the profile history, the source of the alerts, interaction and transaction identifiers, metadata associated with each alert such as the time the alert was generated and which channels the alert was communicated through, and user profile identifiers and account identifiers associated with the alert. Each of digital activity attributes 212, servicing attributes 213, and behavior profile attributes 214 can be driven by specific actions and events driven performed by the entity associated with the user profile, rather than by actions triggered by the smart servicing system communicated to the user profile as is the case for alert attributes. Alert attributes 211 can be accessed via structured query reports (“SQR”) generated based on alerts identified within the computing environment.

The digital activity attributes 212 can include events and actions received by the events hub 106 corresponding to actions by the user profile. Digital activity attributes 212 can include electronic interaction data and previous login activity data, such as the last communication and the last login of the user profile. Login activity data can include profile login frequency, while electronic interaction data can include channel frequency data indicating the frequency by which the user profile accesses or interfaces with given channels (e.g., the relative frequency in which the user profile communicates via mobile application compared to via email, web-application, phone, and the like). Digital activity attributes 212 can include time of contact data, indicating the user profile's historical patterns for contacting the servicing environment, indicated by timestamps and other time-specific data, device data indicating the historical patterns of devices by which the user profile contacts the servicing environment, and periodic online activity durations (e.g., how digitally active a user profile was over a specified period of time). Digital activity attributes 212 can be accessed via a data lake 222 or other centralized repository designed to store large amounts of structured, semi-structured, and unstructured data in its raw format

The servicing activity attributes 213 can include attributes defined by user profile behavior patterns in resolving triggering events (i.e., behavior patterns responsive to the user profile's account being locked or responsive to the user being alerted that fraud was detected on their account) logged according to one or more channels. For instance, user profile behavior patterns including behaviors during communications over a phone call, via mobile device facilitated virtual assistant, or via email can provide servicing activity attributes 213. Servicing activity attributes 213 can include contact channel data, indicating via which channels the user profile is responding to a triggering event, the duration of the interaction (e.g., the duration of a call when the contact channel is via phone), the reason or triggering event which caused the servicing activity, logs of communications during the servicing activity including determined sentiments, the user profile's preferred language identified during servicing activities, the user profile's provided feedback during the servicing activity, and the user profiles most frequent determined most-used intents'traced over multiple servicing activities. The most-used intents refers to the determined outcome of previous interactions, or the underlying intent of the previous interactions. Examples of most-used intents can include a determination as to whether the user profile's previous servicing activities resulted in the user receiving access to certain user profile data including account history, or if such servicing activities resulted in the user profile initiating a specific action such as resetting a password associated with the user profile. Servicing activity attributes can also include duration of interaction data, which records the length of previous servicing interactions as retrieved by the event listeners.

Behavior profile attributes 214 can include attributes determined based on specific statistics, metrics, and behaviors associated with the user profile. Behavior profile attributes 214 can include account tenure data, geographic code data providing the location of the user profile, and the like. In the same and other examples, behavior profile attributes 214 can include withdrawal and deposit histories, banking statements and banking tenure, demand deposit account (“DDA”) balances, online banking activity segments, and a determined likelihood for a user profile balance to grow (e.g., determined based on a previous transaction history associated with the user).

Account attribute 215 can include attribute determined based on account data associated with the user profile. Unlike servicing activity attributes 213, account attributes 215 can capture more general data associated with the user profile not based on specific actions and rather based on more periodic and stable attributes. Account attributes 215 can include account types (e.g., whether the user profile includes a savings and/or a checking account), a current balance on each account, scheduled and recurring payments (e.g., subscriptions) associated with the user profile, and similarly predicted incoming and outgoing expenses. Account attributes can similarly include balance trends associated with the user profile's accounts. In an example, account attributes can capture a predicted subscription debit to a user profile's checking account, and similarly can capture that in combination with another predicted expense, the user profile's checking account is likely to have insufficient funds at the time of the predicted subscription. These attributes, captured as account attributes 215, can be captured by the aggregation engine 114 and subsequently processed by the action recommendation engine to provide an action recommendation to the entity associated with the user profile to cancel the subscription prior to the transaction. Each of the servicing activity attributes 213, the behavior profile attributes 214, and the account attributes 215 can be retrieved from respective system of record (“SOR”) databases including a servicing history & analytics SOR 223, a behavior profile SOR 224, and an account SOR 225.

According to the example table 200 of FIG. 2, each of the sets of attributes 211-215 is categorized by a respective dimension 230 including an alert dimension 231, digital activity dimension 232, servicing activity dimension 233, profile dimension 234, and account activity dimension 235. Each dimension indicates that separate machine-learning models (e.g., action models 120) can be trained according to the respective dimension. Thus, an action model 120 can correspond to the alert dimension 231 trained on alert attributes 211. Additional action models can be trained according to the other dimensions 232-235. In such a manner, respective action models 120 can be finely tuned according to each set of attributes 211-215.

When implemented into the action recommendation engine 118, the action models 120 may then allow for a combination of determinations to formulate the action recommendation. For instance, the profile dimension 234, account activities dimension 235, and corresponding action models can be used to determine an action recommendation (e.g., cancel a card based on a suspicious transaction determined in via the profile dimension 234, while adjusting subscriptions charging to the identified card via the account activity dimension). In tandem, the digital activity dimension 232 and corresponding action model 120 can determine that the user profile should receive the action recommendation at a specified time on a specified device via a specified channel.

### Example Operations for Determining Next Best Actions

FIG. 3 shows an example process for determining next best actions based on user profiles and associated user attributes, according to certain embodiments. For illustrative purposes, the process 300 is described with reference to implementations described above with respect to one or more examples described herein. Other implementations, however, are possible. In some aspects, the operations in FIG. 3 may be implemented in program code that is executed by one or more computing devices such as the computing environment 100 of FIG. 1. In some aspects of the present disclosure, one or more operations shown in FIG. 3 may be omitted or performed in a different order. Similarly, additional operations not shown in FIG. 3 may be performed.

At block 302 the process 300 includes receiving an event identification and a credential verification. The event identification includes a data structure identifying a triggering event that is to be or has been communicated to the end user computing device 104. In some examples, the smart servicing system 102 can generate the triggering event and event identification such that the smart servicing system 102 generates and receives the event identification. In other examples, the event can be generated by another computing system within the computing environment 100 where the triggering event is transmitted to the end user computing device 104. However, when accessing the end user computing device 104, the event identification can be subsequently transmitted to the smart servicing system 102 such that the smart servicing system 102 receives the event identification. In such a manner, the smart servicing system 102 can determine a specific event to respond to and to determine an action recommendation from.

The credential verification can be received by the end user computing device 104 in response to an entity logging into the end user computing device and authenticating their identity. The credential verification can both confirm that the smart servicing system 102 is authorized to communicate with the end user computing device 104 while also indicating to the smart servicing system 102 what user profile the end user computing device 104 is associated with.

At block 304 the process 300 includes generating a login event including the event identification and credential verification. The login event can be received at the event hub 106 by an event listener 108. The login event includes the event identification which can be processed by the aggregation engine 114 into attributes as stored in the repository 116 (e.g. digital activity attributes 212. The credential verification, indicating the user profile can similarly be processed by the aggregation engine 114, allowing the action recommendation engine 118 to retrieve specific attributes associated with the user profile.

At block 306 the process 300 includes monitoring two or more data source via parallel processing to generate a set of user profile attributes of each entity of a set of one or more entities. The set of user profile attributes can include the sets of attributes discussed with respect to FIG. 2. For instance, each of the alert attributes 211, the digital activity attributes 212, servicing activity attributes 213, behavior profile attributes 214, and account attributes 215 can be used to generate the user profile attributes. In other examples, a subset of the attribute table 200 of FIG. 2 can be used as the user profile attributes (e.g., including alert attributes 211, behavior profile attributes 214, but not account attributes 215, or another combination of the attribute set 210). Each of the sets of attributes can be received via parallel processing from one or more of the databases discussed with respect to FIG. 2, including receiving the alert attributes 211 from the SQR for alerts 221, the digital activity attributes 212 from the data lake 222, and each of the servicing activity attributes 213, behavior profile attributes 214, and account attributes 215 from respective SOR 223-225.

The operations per block 306 can be performed periodically or in response to various triggering events. For instance, the smart servicing system 102, via the aggregation engine 114 can be configured to gather data from the respective data sources 112 (including databases 220) on a periodic basis, where periodic rates may be adjusted depending on the data source. Additionally or alternatively, event listeners 108 configured to monitor respective data sources 112 can be configured to update the sets of attributes and thus the generated set of user profile attributes, responsive to detected events from the respective data source. Through configuration of separate data sources with respective event listeners and through parallel processing, collection of user attributes can be optimized.

At block 308 the process 300 includes identifying an associated entity of the set of one or more entities based on the login event. As discussed with respect to block 304, the login event can include credential verifications which can indicate to the smart servicing system 102 what user profile the end user computing device 104 is associated with. Per block 306, user attributes can be generated for each entity of a set of one or more entities, where each entity has a respective user profile representing the entity in a digital domain. While at block 308, in providing a specific user interface for a given entity and respective user profile via an end user computing device 104 and virtual assistant service 126, the smart servicing system 102 determines the entity and associated user profile from the login event. Therefore, while process 300 can include generating user attributes for a plurality of entities via monitoring various data sources 112 via an event hub 106, block 308 links the user attribute generation process to a specific entity accessing the smart servicing system 102 via a given end user computing device 104.

At block 310 the process 300 includes determining a user behavior profile based on the set of user attributes of the associated entity. Determining the user behavior profile based on the set of user attributes can include first, retrieving the user attributes of the given entity based on the associated entity identified at block 308. The user attributes can include a combination of the attributes or sets of attributes discussed with respect to FIG. 2, relative to the user profile of the associated entity. The event hub 106 of the smart servicing system 102 can receive a plurality of events and actions for aggregation into sets of attributes for each entity with access to the smart servicing system. As received from various data sources 112, and/or during aggregation via the aggregation engine 114, each set of events data can be classified by the associated user profile. With the associated entity identified per block 308, the process 300 at block 310 can then determine the user behavior profile of the associated entity by retrieving the attributes classified as associated with the entity's user profile.

At block 312 the process 300 includes determining an action recommendation and one or more channels for communicating the action recommendation based on the login event and user behavior profile. Determining an action recommendation and channel for communication can include applying the set of user attributes of the associated entity to the action recommendation engine 118 (which may not comprise an ensemble model including a plurality of action models). The action recommendation engine 118 can comprise hard coded logic, a machine-learning model, or some combination of each. As a machine-learning model, the action recommendation engine 118 can be trained on a series of attributes including those discussed with respect to FIG. 2, where the series of attributes can correspond to a larger set of accounts and would not be limited to a single user profile. In other words, the training set used to train the action recommendation engine 118 can include large sets of previous user interactions as logged or accessed by the smart servicing system 102, where the training set is decomposed into features or attributes corresponding to those discussed with respect to FIG. 2.

In some instances, the action recommendation engine 118 can comprise an ensemble model including multiple action models 120, where each action model 120 is a separately trained machine-learning model. Each action model can be trained on a separate attribute dimension 230 as discussed with respect to FIG. 2. Separate action models 120 trained relative to separate attribute dimensions 230 can provide greater accuracy in determining the parameters of the action recommendation including the recommendation to make (determined by a profile dimension 234 and account activities dimension 235 trained action model), when to provide the recommendation (e.g., via an alert dimension 231 trained action model), and via what channel to provide the recommendation (e.g., via what device as determined by a digital activity dimension 232 trained action model).

Determining the channel(s) via which to communicate the recommendation can include evaluation of multiple candidate electronic channels, representing all possible means of communicating with an entity across multiple types of electronic devices. Examples of candidate channels can include a mobile application channel, a web-host channel, a text-based channel (e.g., email channel or instant messaging channel), a call channel, and the like. Based on the attributes aggregated per aggregation engine 114, and discussed with respect to FIG. 2, such as the digital activity attributes 212, the action recommendation engine can make the determination of which channel(s), among the candidate channels to communicate the action recommendation through.

In some examples, the action recommendation engine 118 can determine a series of candidate action recommendations, or the action recommendation to provide to a given user profile prior to the associated entity logging into the virtual assistant service 126. Rather, based on previous login and activity patterns, aggregated into attributes, the action recommendation engine 118 can periodically, or in response to various events, generate action recommendations which are then stored in a repository 116. Then, in response to the login event, the action recommendation engine 118 can determine the associated user profile and retrieve the predetermined action recommendation to provide to entity per block 314.

At block 314 the process 300 includes transmitting the action recommendation to one or more channels. Per preceding blocks, the process can determine a preferred set of channels and end user computing devices 104 via which to communicate the action recommendation to an entity. For instance, user profile behavior patterns, determined via the action recommendation engine 118 or constituent action models 120, can indicate that the user profile's preferred means of contact is via an associated mobile device and mobile application. In response, the determined action recommendation can be transmitted to the mobile device and mobile application. In another example, previous events and interactions via the mobile application (e.g., determined via sentiment analysis and sentiment attributes within the servicing activity attribute 213) may indicate that that the user profile was previously dissatisfied with the mobile experience, and as a result, the action recommendation engine 118 may cause an action recommendation to be transmitted via email, web-services, or another channel of communication. In such a manner, the action recommendation engine 118 can learn a user profile's preferred channels of communication and tailor future communications and action recommendations to the user profile via those preferred channels.

### Additional Operations for Determining Next Best Actions

FIG. 4 shows processes for determining action recommendations based on user profiles and associated user attributes, according to certain examples. For illustrative purposes, the processes 400, 410 are described with reference to implementations described above with respect to one or more examples described herein. Other implementations, however, are possible. In some aspects, the operations in FIG. 4 may be implemented in program code that is executed by one or more computing devices such as the computing environment 100 of FIG. 1. In some aspects of the present disclosure, one or more operations shown in FIG. 4 may be omitted or performed in a different order. Similarly, additional operations not shown in FIG. 4 may be performed.

According to the example of process 400, one means for identifying action recommendations can include digesting user attributes such as behavior profile attributes 214 and account attributes 215 to predict pending transactions prior to the transactions occurring. By identifying a predicted transaction, the action recommendation engine 118 can proactively notify a user profile of a recommended action to avoid potential negative consequences of a predicted event occurring. For example, a predicted event can include a recurring transaction, such as a subscription, identified as an account attribute 215. Another event can be identified including a card cancellation, identified as a servicing activity attribute 213, where the card cancelled is associated with the subscription. In response, the action recommendation engine 118 can determine an action recommendation is necessary to avoid a failed transaction due to the card cancellation. The action recommendation can then further determine the preferred action to take, such as cancelling the subscription or updating the subscription to a new card, based on additional attributes associated with the user profile.

At block 402 the process 400 includes identifying a pending event based on the user behavior profile. The pending event can be determined based on various attributes of the user profile, including behavior profile attributes 214 and account attributes. In some examples, the account attributes can be static, recurring transactions such a subscriptions and scheduled payments. In other examples, pending events can include predicted behaviors such as significant withdrawals from a user profile's account, predicted by the action recommendation engine based on previous behavioral patterns and account attributes 215. For instance, account attributes 215 including spending patterns can be processed by the action recommendation engine 118 to determine a significant transaction is likely to occur again in the near future.

At block 404 the process 400 includes determining an action recommendation based on the pending event. Having determined a pending event is likely to occur, such as a recurring transaction, or a high likelihood of significant expenditures based on spending history attributes, the action recommendation engine 118 can determine an action recommendation. The action recommendation can include less intrusive alerts, merely indicating to the user that a recurring transaction is expected, or that the user should consider saving at a given point in time based on a previously determined pending action including large spend. The action recommendation can also include more proactive actions, such as moving funds from one account to another based on an expected overdraft in an account to be charged. Thus, pending events can include multiple cascading events, where a first pending event determined by the action recommendation engine 118 can include a predicted recurring transaction, while a second pending event contingent on the first can include an expected overdraft event. The action recommendation engine 118, in determining a likelihood of both events occurring, can generate action recommendations to mitigate one or both. How the action recommendation is determined can be based on additional user attributes, including further profile attributes.

Additional means for determining action recommendations can be based on feedback processed by a scoring engine 128. Feedback can be directly provided in response to user feedback via the virtual assistant service 126, for instance, via explicit ratings of previously provided action recommendations. Additionally or alternatively, feedback can be gathered implicitly based on sentiment analysis enabled by an NLP engine 128, or via monitoring subsequent actions responsive or non-responsive to previously provided action recommendations. The example process 410 provides an example means for intelligently, automatically tailoring a user interface experience based on monitoring responses to previous action recommendations.

At block 412, the process 410 includes transmitting the action recommendation. Block 412 is similar to block 314, and can represent a first action recommendation, determined by the action recommendation engine 118, being delivered to a user profiles via one or more channels. As with block 314, the action recommendation engine 118 can similarly determine the preferred channel and time of communication.

At block 414, the process 410 includes, subsequent to transmitting the action recommendation, logging a subsequent event history. Logging the subsequent event history can begin with logging the first action recommendation, including logging the specific recommended action, the channel(s) via which the action recommendation was provided, the time the first action recommendation was provided, and the like. Subsequent user interactions and events, as can be retrieved via event listeners 108 into an event hub 106 and aggregated can then be stored in the repository 116 as attributes. The attributes comprising the subsequent event history can include any of those discussed with respect to FIG. 2, where the attributes are aggregated by the aggregation engine 114 subsequent to the action recommendation being transmitted, where timestamp metadata associated with each of the attributes and the action recommendation can be used to determine the relative timing of the subsequent event history and the action recommendation.

At block 416, the process 410 includes retraining one or more of a plurality of machine-learning models used to determine the action recommendation based on the subsequent event history. Per block 414, the subsequent event history may be decomposed into attributes to be processed by the action recommendation engine 118. In some examples, the subsequent event history attributes can be separately weighted by the action recommendation engine 118 during the retraining phase. For example, subsequent event history attributes may be stored as more heavily weighted attributes, loss functions within the action recommendation engine 118 associated with the subsequent event history attributes can be more heavily weighted, or the action recommendation engine 118 hyperparameters can be adjusted to more heavily weigh the subsequent event history attributes. In such examples, future performance of the action recommendation engine 118 and the smart servicing system 102 more generally, can be improved relative to each user's preferred means'for interaction with a servicing interface.

### Example Operations for Generating Attributes for Determining Next Best Actions

FIG. 5 shows processes 500, 510 for determining next best actions based on user profiles and associated user attributes, according to certain examples. For illustrative purposes, the processes 500, 510 are described with reference to implementations described above with respect to one or more examples described herein. Other implementations, however, are possible. In some aspects, the operations in FIG. 5 may be implemented in program code that is executed by one or more computing devices such as the computing environment 100 of FIG. 1. In some aspects of the present disclosure, one or more operations shown in FIG. 5 may be omitted or performed in a different order. Similarly, additional operations not shown in FIG. 5 may be performed.

To optimize performance of the smart servicing system 102, the event listeners 108 can be assigned to respective data sources 112 via parallel processing to reduce the number of operation calls and processor cycles in obtaining events used to generate attributes. Process 500 shows an example set of operations for optimizing event retrieval and attribute generation, according to certain examples. Process 500 thus illustrates an example set of operations per blocks 502-506 illustrating the operations of monitoring two or more data sources via parallel processing to generate a set of user attributes for each entity of a set of one or more entities similar to the operations of block 306 in process 300.

At block 502, the process 500 includes retrieving, at a first rate, first velocity data. The first velocity data can include alert data used to generate the alert attributes 211, and can be retrieved from the SQR for alerts 221. Thus, an event listener 108 can be configured to independently monitor alert data for aggregation into alert attributes 211. The first velocity data can also include data associated with other attributes such as digital activity data corresponding to digital activity attributes 212, where an event listener 108 is directly configured to monitor the data lake 222 providing digital activity data. As compared to the second velocity data, the first velocity data may have a higher velocity (i.e., rate of change evidenced by more frequent event generation). Thus, first velocity data event listeners 108 for retrieving first velocity data can be adjusted to monitor the higher velocity dimensions 230 as compared to the second velocity data.

At block 504, the process 500 includes retrieving, at a second rate, second velocity data. The second velocity data includes that data which has a lower rate of change such as occurring to less frequent event generations in the respective dimension 230. For example, the servicing activities dimension 233, generating data via the servicing history and analytics SOR 223, may produce data at a lower velocity compared to the SQR for alerts 221 providing data in the alert dimension 231 (also referred to as the alerts and notifications dimension). In response, an event listener 108 associated with the servicing history and analytics SOR 223 may be configured to retrieve data at a lower rate or frequency as compared with the event listener 108 pulling data from the first velocity data source.

At block 506, the process 500 includes determining a user behavior profile based on the first velocity data and the second velocity data. Operations at block 516 are similar to those discussed with respect to block 310 of process 300 and can be implemented as part of the same series of operations. For instance, the operations per process 500 can be implemented as an aspect of operations per block 306 in process 300.

As discussed above, in a preferred example, the action recommendation engine 118, providing means for generating action recommendations, and for determining which of one or more channels for communicating the action recommendation, can take the form of an ensemble model. The ensemble model can comprise a plurality of action models 120 (e.g., machine-learning models particularly configured to make particular predictions based on assigned sets of attributes). Process 510 further illustrates an example process of utilizing an ensemble-based action recommendation engine 118. For example, the ensemble model can comprise a first model trained on digital activity attributes, a second model trained on servicing activity attributes; and a third model trained on the user profile attributes.

At block 512, the process 510 includes generating a set of user profile attributes for an entity. Block 512 is similar to block 306, where multiple data sources may be monitored via parallel processing and event monitors 108 to generate sets of user attributes. Particularly, the multiple data sources can include two or more of those described with respect to FIG. 2 including the SQR for alerts 221, data lake 222, servicing history & analytics SOR 223, Behavior profile SOR 224, and account SOR 225. Each of the data sources may be aggregated into a repository 116, where the attributes may be maintained separate for separate processing by respective machine-learning models per block 516.

At block 514, the process 510 includes applying the set of attributes to an ensemble determination model comprising a plurality of machine-learning models. Each respective set of user attributes, including alert attributes 211, digital activity attributes 212, servicing activity attributes 213, behavior profile attributes 214, and account attributes may be provided to a separate action model 120, where two or more of the separate action models 120 in combination comprise the plurality of machine-learning models.

At block 516, the process 510 includes determining an action recommendation based on a set of outputs generated by the plurality of machine-learning models. Determining the user behavior profile can include bagging, boosting, stacking, voting, and other ensemble based approaches. For instance, the output of each action model of the plurality of action models can be weighted and summed for final determination via the action recommendation engine 118 under a bagging approach. In bagging examples, for instance, the an action model scoring the servicing activity attributes 213 may output an action recommendation score weighed more heavily than an action model scoring the behavior profile attributes 214.

In other examples, plurality of action models comprising the ensemble-based action recommendation engine 118 may be configured to determine a different parameter of the action response. For instance, an action model configured to score digital activity attribute 212 can determine the channel, device, and time for transmitting an action recommendation, while action models for scoring behavior profile attributes 214 and account attributes 215 can determine the specific action recommendation, and action models trained for scoring the servicing activity attributes can identify a particular manner of communicating the action recommendations (i.e., the language, sentiment, and order for providing multiple action recommendations.

### Example Computing Environment for Determining Next Best Actions

Any suitable computing system or group of computing systems forming a computing environment can be used for performing the operations described herein. For example, FIG. 6 shows a block diagram for a computing environment 600 capable of executing the described systems and methods, according to certain examples.

The depicted example of a computing system 602 includes one or more processors 606 communicatively coupled to one or more memory components 604. The processor 606 executes computer-executable program code or accesses information stored in the memory component 604. Examples of processor 606 include a microprocessor, an application-specific integrated circuit (“ASIC”), a field-programmable gate array (“FPGA”), or other suitable processing device. The processor 606 can include any number of processing devices, including one.

The memory component 604 includes any suitable non-transitory computer readable medium for storing the action engine 622, event hub logic 624 (i.e., including operations controlling event listeners and event publishers), the virtual assistant service 626, or other dynamic instructions 628. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 602 may also include a number of external or internal devices such as input or output devices. For example, the computing system 602 is shown with an input/output (“I/O”) interface 610 that can receive input from input devices or provide output to output devices. A bus 608 can also be included in the computing system 602. The bus 608 can communicatively couple one or more components of the computing system 602.

The computing system 602 executes program code that configures the processor 606 to perform one or more of the operations described above with respect to FIGS. 1-5. The program code includes operations related to, for example, configuring event listeners to retrieve data, aggregate event data into actions, train and apply machine learning models based on attributes, or other suitable applications or memory structures that perform one or more operations described herein. The program code may be resident in the memory component 604 or any suitable non-transitory computer-readable medium and may be executed by the processor 606 or any other suitable processor. In some embodiments, the program code described above, including the action engine 622, event hub logic 624, the virtual assistant service 626, or other dynamic instructions 628 are stored in the memory component 604, as depicted in FIG. 6. In additional or alternative embodiments, one or more of the action engine 622, event hub logic 624, the virtual assistant service 626, or other dynamic instructions 628 described above are stored in one or more memory components accessible via a data network 614, such as a memory component accessible via a cloud service.

The computing system 602 depicted in FIG. 6 also includes at least one network interface 612. The network interface 612 includes any device or group of devices suitable for establishing a wired or wireless data connection to one or more data networks 614 such as viewing applications 620 including user interfaces. Non-limiting examples of the network interface 612 include an Ethernet network adapter, a modem, and/or the like. A remote communication service 618 is connected to the computing system 602 via network 614 and can perform some of the operations described herein configuring event listeners to retrieve data, aggregate event data into actions, train and apply machine learning models based on attributes. The computing system 602 is able to communicate with one or more of the remote communication service 618 and data sources 616. Data sources 616 can include any of the data sources according to the examples described herein, such as data sources 112, including the databases 220 (i.e., 221-225). In other examples, one or more of the data sources 616 can be stored within the computing system 602 such that transmission across network 614 is not necessary.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving an event identification and a credential verification;
generating a login event including the event identification and credential verification;
monitoring two or more data sources via parallel processing to generate a set of user attributes for each entity of a set of one or more entities;
identifying an associated entity of the set of one or more entities based on the login event;
determining a user behavior profile for the associated entity based on the set of user attributes of the associated entity;
determining an action recommendation and one or more electronic channels for communicating the action recommendation based on the login event and user behavior profile; and
transmitting the action recommendation to the one or more electronic channels.

2. The method of claim 1, wherein determining the user behavior profile includes:
generating a set of attributes based on the event identification and the credential verification;
applying the set of attributes to an ensemble determination model comprising a plurality of machine-learning models; and
determining the user behavior profile based on a set of outputs generated by the plurality of machine-learning models.

3. The method of claim 2, wherein the set of attributes includes digital activity attributes comprising one or more of channel frequency data, time of contact data, device data, and login activity data.

4. The method of claim 2, wherein the set of attributes includes servicing activity attributes comprising one or more of most-used intents, contact channel data, and duration of interaction data.

5. The method of claim 2, wherein the set of attributes includes behavior profile attributes and account attributes comprising one or more of account activity data, account tenure data, and geographic code data.

6. The method of claim 2, wherein the plurality of machine-learning models includes a first model trained on digital activity attributes, a second model trained on servicing activity attributes; and a third model trained on the user profile attributes.

7. The method of claim 1, wherein determining the action recommendation comprises:
identifying a pending event based on the user behavior profile; and
determining the action recommendation based on the event identification and the pending event.

8. The method of claim 1, wherein the one or more electronic channels for communicating the action recommendation are chosen from among a set of candidate channels including a mobile application channel, a web-host channel, a text-based channel, and a call channel.

9. The method of claim 1, further comprising, subsequent to transmitting the action recommendation:
logging a subsequent event history; and
retraining one or more of a plurality of machine-learning models used to determine the action recommendation based on the subsequent event history.

10. The method of claim 1, wherein determining the user behavior profile comprises:
retrieving, at a first rate, first velocity data;
retrieving, at a second rate, second velocity data, wherein the first rate is higher than the second rate; and
determining the user behavior profile based on the first velocity data and the second velocity data.

11. A system comprising:
a memory component; and
a processing device coupled to the memory component, the processing device to perform operations comprising:
receiving an event identification and a credential verification;
generating a login event including the event identification and credential verification;
monitoring two or more data sources via parallel processing to generate a set of user attributes for each entity of a set of one or more entities;
identifying an associated entity of the set of one or more entities based on the login event;
determining a user behavior profile for the associated entity based on the set of user attributes of the associated entity;
determining an action recommendation and one or more electronic channels for communicating the action recommendation based on the login event and user behavior profile; and
transmitting the action recommendation to the one or more electronic channels.

12. The system of claim 11, wherein determining the user behavior profile includes
generating a set of attributes based on the event identification and the credential verification;
applying the set of attributes to an ensemble determination model comprising a plurality of machine-learning models; and
determining the user behavior profile based on a set of outputs generated by the plurality of machine-learning models.

13. The system of claim 12, wherein the set of attributes includes digital activity attributes comprising channel frequency data, time of contact data, device data, and login activity data.

14. The system of claim 12, wherein the set of attributes includes servicing activity attributes comprising most-used intents, contact channel data, and duration of interaction data.

15. The system of claim 12 wherein the set of attributes includes behavior profile attributes and account attributes comprising one or more of account activity data, account tenure data, and geographic code data.

16. The system of claim 15, wherein the plurality of machine-learning models includes a first model trained on digital activity attributes, a second model trained on servicing activity attributes; and a third model trained on the user profile attributes.

17. The system of claim 11, wherein determining the action recommendation comprises:
identifying a pending event based on the user behavior profile; and
determining the action recommendation based on the pending event.

18. The system of claim 11, wherein the one or more electronic channels for communicating the action recommendation are chosen from among a set of candidate channels including a mobile application channel, a web-host channel, a text-based channel, and a call channel.

19. The system of claim 11, wherein the operations further comprise, subsequent to transmitting the action recommendation:
logging a subsequent event history; and
retraining one or more of a plurality of machine-learning models used to determine the action recommendation based on the subsequent event history.

20. A non-transitory computer-readable medium storing executable instructions, which when executed by a processing device, cause the processing device to perform operations comprising:
receiving an event identification and a credential verification;
generating a login event including the event identification and credential verification;
monitoring two or more data sources via parallel processing to generate a set of user attributes for each entity of a set of one or more entities;
identifying an associated entity of the set of one or more entities based on the login event;
determining a user behavior profile based for the associated entity based on the set of user attributes of the associated entity;
determining an action recommendation and one or more electronic channels for communicating the action recommendation based on the login event and user behavior profile; and
transmitting the action recommendation to the one or more electronic channels.
